(19) United States
(12) Patent Application Publication
(10) Pub. No.: US 2002/0157300 A1
(43) Pub. Date: Oct. 31, 2002

(54) Fishing lure having a rotational and reflective body portion

(76) Inventor: John R. Saul, Boca Raton, FL (US)

Correspondence Address: MELVIN K. SILVERMAN, 4901 N. FEDERAL HWY., SUITE 410, FT. LAUDERDALE, FL, 33308, US

(21) Appl. No.: 09/844,868

(22) Filed: Apr. 30, 2001

(51) Int. Cl. A01K 85/00

(52) U.S. Cl. 43/42.33

(57) ABSTRACT

A lure and fish attractor includes a non-rotational rigid head assembly, a non-rotational rigid tail assembly, a rigid axle therebetween defining a longitudinal axis of the lure for securing the head and tail assemblies to each other. A solid hub-like cylindrical body portion having an axial channel therewithin is rotationally mounted about the rigid axle. Optical means such as mirrored strips or prismatic film are longitudinally adhered to an inner circumferential surface of the body portion. An outer circumferential surface of the body portion is radially secured to the inner surface and is substantially transparent. Rigidly attached to the outer surface of the cylindrical body portion are spirally slanted fins which induce rotation of the cylindrical body upon the axle reactive to water force impacting upon the fins when the lure is towed upon a fish line associated with a fishing boat. Various fish-attractive optical effects are achieved from the resultant rotation of the body portion and the optical means provided therein.

### BACKGROUND OF THE INVENTION

1. Field of Invention

The instant invention relates to a fish attractor, also known as a fishing lure, spinner or teaser.

2. Prior Art

Fish attractors, generically known as fishing lures, are well known to fishermen, particularly to those who troll for game fish in deep waters, this known as blue or salt water or game fishing. A variety of such attachments are known in the art. Generally, the particular shape and configuration of a lure determines its pattern of motion and its rotation if any. Therein, the type of material used upon the lure will determine the nature of any reflection, refraction or light emanating therefrom. Lures, of the present type, are more specifically known as flashers, as opposed to spinners which are attached to a leader next to hook. As such, flashers are larger fishing appurtances and are designed to look like another fish swimming through the water.

In the prior art, flashing or optical lures typically rely on a particular combination of angles or fold lines to define the rotational characteristic thereof. U.S. Pat. No. 4,041,636 (1977) to Folker, entitled Trolling Accessory For Fishing; and U.S. Pat. No. 5,970,648 (1999) to DeRose, entitled Dual Action Multi-Line Fish Attractor, are characteristic of fish lures of this type.

Certain lures, primarily of the spinner category, employ angulation of simulated wings or fins of a false fish to induce spinning of a reflective body portion thereof. See for example U.S. Pat. No. 5,016,387 (1999) to Beaupre, entitled Fishing Lure Having A Spinnable Buoyant Body Equipped With Reflective Surface Fins. Other lures of a reflective type employ spinners in combination with elongate transparent bodies filled with optically attractive materials such as gels or films. See for example U.S. Pat. No. 5,044,110 (1991) to Henderson, entitled Reflective Lure.

Non-rotational reflective lures that utilize a combination of prismatic and mirrored elements are well known in salt water fishing as are shown in such publications as 2001 The Johnny Morris Offshore Angler and Salt Water Sportsmen. A patent teaching a lure of this type is U.S. Pat. No. 4,922,646 (1990) to Basgal, entitled Fishing Lure. It is thereby to be appreciated that the use of a transparent or semi-transparent housing to encapsulate optically attractive structures or media is well known in the art. It has however been discovered that lures of such type are far more effective if the entire housing thereof can be caused to rotate in a naturally appearing fashion, and if the assembly in general bears dimensional and other similarity to the type of fish which one wishes to attract.

U.S. Pat. No. 3,947,989 (1976) to Bart, entitled Fishing Equipment, teaches a fishing lure having a longitudinal internal chromatic structure and an external surface that imparts a darting or zip-zag motion thereto. The lure itself however does not teach the use of a fluid dynamic structure attached to the periphery thereof to induce a uniform rotation to optical means thereof.

In view of the above, the present invention responds to a long felt need in the area of sport and commercial fishing, and particularly with respect to larger game fish inclusive of marlin, tuna, sailfish, and the like, for a lure effective in attracting such fish.

### SUMMARY OF THE INVENTION

The instant lure and fish attractor includes a non-rotational rigid head assembly, a non-rotational rigid tail assembly, a rigid axle therebetween defining a longitudinal axis of the lure for securing said head and tail assemblies to each other. A solid hub-like cylindrical body portion having an axial channel therewithin is rotationally mounted about said rigid axle. Optical means such as mirrored strips or prismatic film are longitudinally adhered to an inner circumferential surface of said body portion. An outer circumferential surface of said body portion is radially secured to said inner surface and is substantially transparent. Rigidly attached to said outer surface of said cylindrical body portion are spirally slanted fins which thereby induce rotation of said cylindrical body upon said axle reactive to water force impacting upon said fins when the lure is towed upon a fish line associated with a fishing boat. Various fish-attractive optical effects are achieved from the resultant rotational motion of said body portion and the optical means provided therein.

It is accordingly a principal object of the invention to provide an improved fishing lure and teaser particularly adapted for use in the area of large game sports and commercial fishing.

It is another object to provide a fishing lure and teaser of the above type that will simulate the movement of fish and fish bait through water as the lure is towed by the fishing boat.

It is a further object of the invention to provide a fishing lure and teaser which is durable and cost-effective for the above set forth purposes.

The above and yet other objects and advantages of the present invention will become apparent from the hereinafter set forth Brief Description of the Drawings, Detailed Description of the Invention and claims appended herewith.

### BRIEF DESCRIPTION OF THE DRAWINGS

FIG. 1 is a front elevational view of a first embodiment of the inventive fishing lure.

FIG. 2 is a radial cross-sectional view taken along Line 2-2 of FIG. 1

FIG. 3 is an axial cross sectional view taken along Line 3-3 of FIG. 1.

FIG. 4 is an exploded view showing the relationship between the lure axle, the rotational body portion, and the non-rotational head and tail assemblies thereof.

FIG. 5 is a side elevational view of a second embodiment of the invention.

FIG. 6 is a side perspective view of a third embodiment thereof.

FIG. 7 is a radial view taken along Line 7-7 of FIG. 6.

FIG. 8 is a perspective view of a fourth embodiment in which the reflective elements thereof are adhered to the external surface of the body portion.

### DETAILED DESCRIPTION OF THE INVENTION

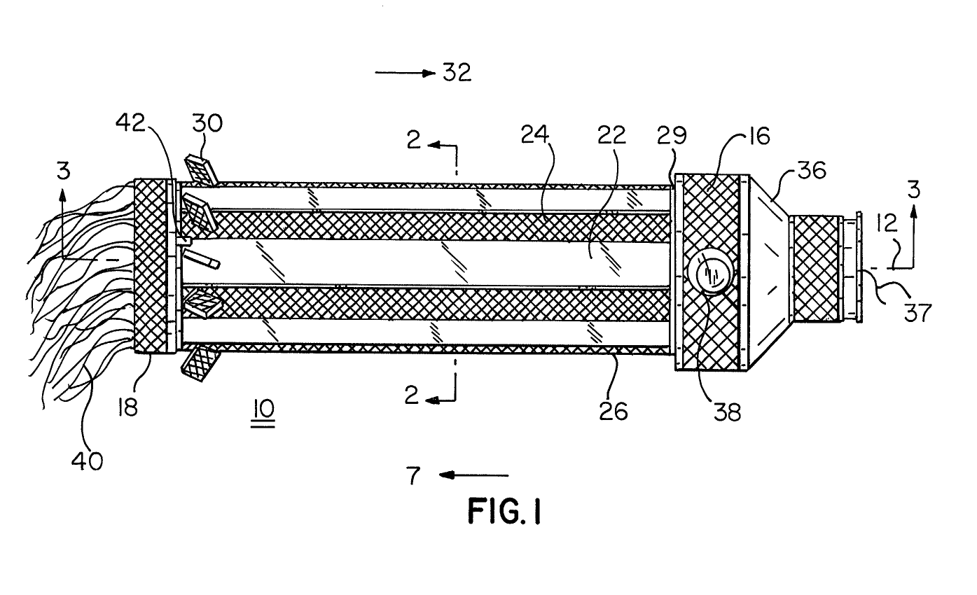

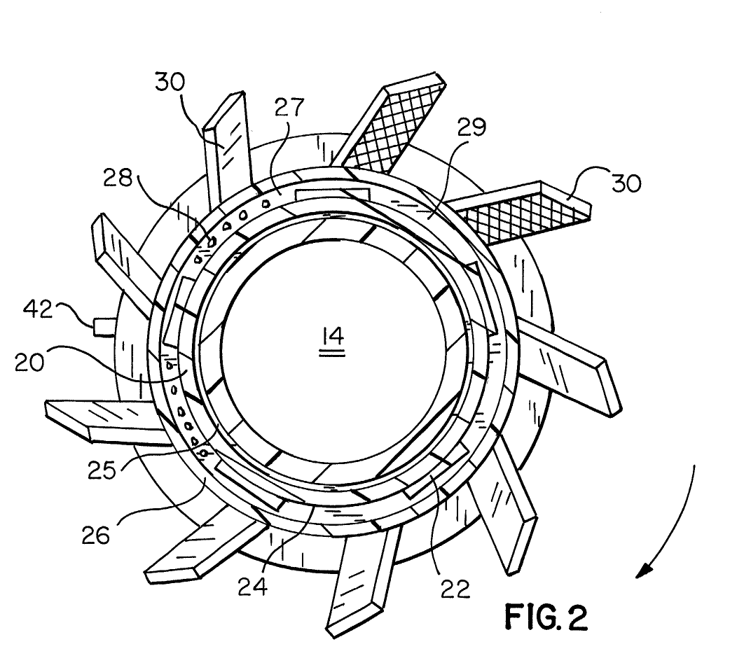

With reference to the side elevational view of FIG. 1, the present inventive rotational and reflective fishing lure and teaser 10 may be viewed in terms of polar coordinates which define both its structure and function. More particularly, there is shown in FIGS. 1 to 3 a longitudinal axis of rotation 12, about which a number of annular elements are disposed, this as may be appreciated with reference to the radial cross-sectional view of FIG. 2. That is, upon said axis of rotation 12 is positioned a fixed shaft or axle 14 which is rigidly secured between a radial front plate 16 and a radial back plate 18. Accordingly, axle 14 is secured within recesses 15 of said plates 16 and 18 to define a stationary axis of the inventive system.

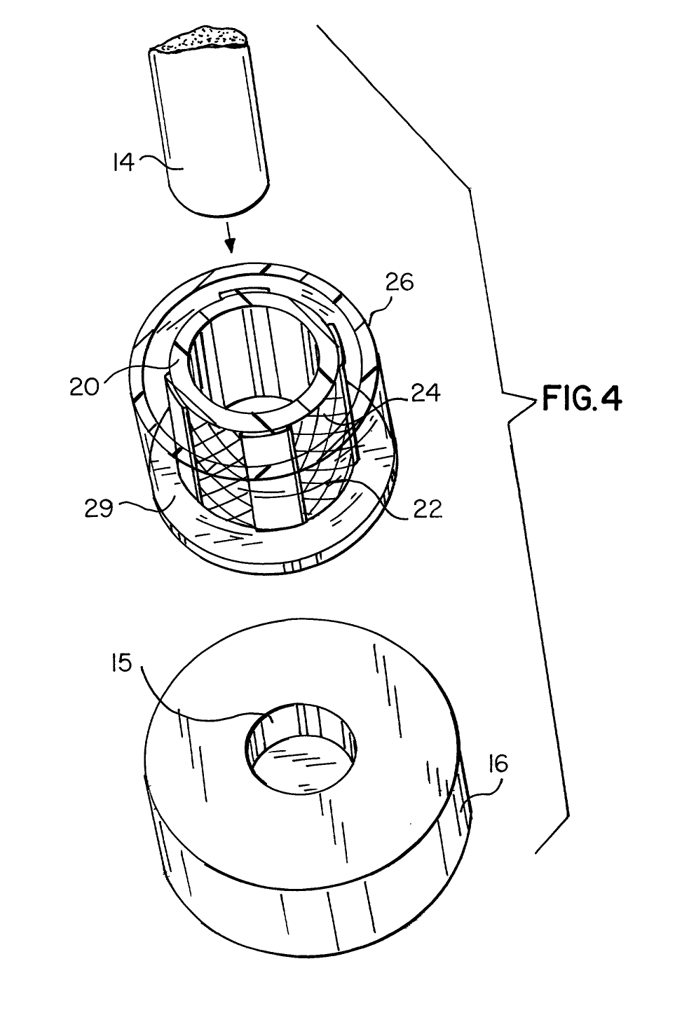

Radially outwardly of said axle 14 is a complemental inner cylindrical sleeve 20 which is secured in fixed rotational relationship to an outer rotational sleeve 26 (see FIG. 4) by rigid annular elements 29 at each end of axle 14 to create a hub-like structure. An annular space 25 exists between axle 14 and sleeve 20. This structure which operates to encapsulate said inner sleeve 20 and alternating mirrored and prismatic surfaces 22 and 24 respectively which are longitudinally adhered to sleeve 20. Further, transparent and/or iridescent beads 28 may be provided within an annular region 27 between the respective inner and outer sleeves 20 and 26, and over the prismatic surfaces 24, to thereby enhance the optical effect and provide a fish-attractive rattling noise during rotation of the sleeves 20 and 26 upon axle 14. It is noted that outer sleeve 26 is substantially transparent.

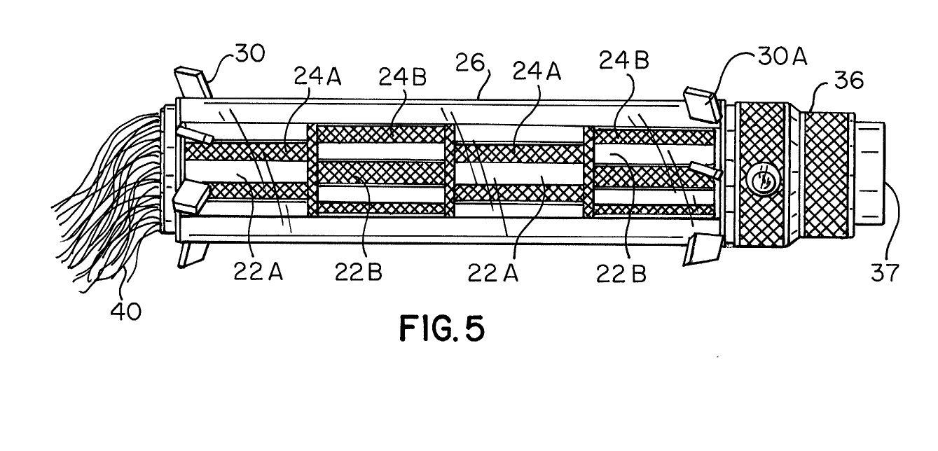

The hub-like combination of inner sleeve 20 and outer transparent sleeve 26 will thereby rotate upon axle 14 powered by a dynamic effect of water (see “water direction” arrow of FIG. 1) against spiral radial fins 30 that are rigidly adhered to said outer sleeve 26. Thereby, the lure 10, when towed in boat direction 32, will produce a re-active water force 34 against said fins 30 thereby causing the outer sleeve 26 and the entire hub-like structure to rotate in a windmill-like or venturi fashion as water pressure 34 impacts against the slanted fins. It should be understood that, absent appropriate angulation of the surfaces of fins 30, the longitudinal sleeves 20 and 26 will not rotate in a consistent fashion. Thereby, positioning of fins 30 upon outer shell 26 must be in a windmill relationship, that is, a virtual spiral, relative to system axis 12. Therein, a plurality of sets of fins as is shown in the embodiment of FIG. 5 may also be employed.

A consequence of the tandem rotation of outer and inner sleeves 20 and 26 exotic optical effects of said mirrored surfaces 22, said prismatic surfaces 24 and, optionally, said transparent and/or iridescent beads 28 disposed within annular region 25 between said sleeves will occur. It has been determined that this rotational and reflective effect is most attractive to fish of may types but, particularly, to fish in the 40 to 200 pound range, this inclusive of blue water tuna.

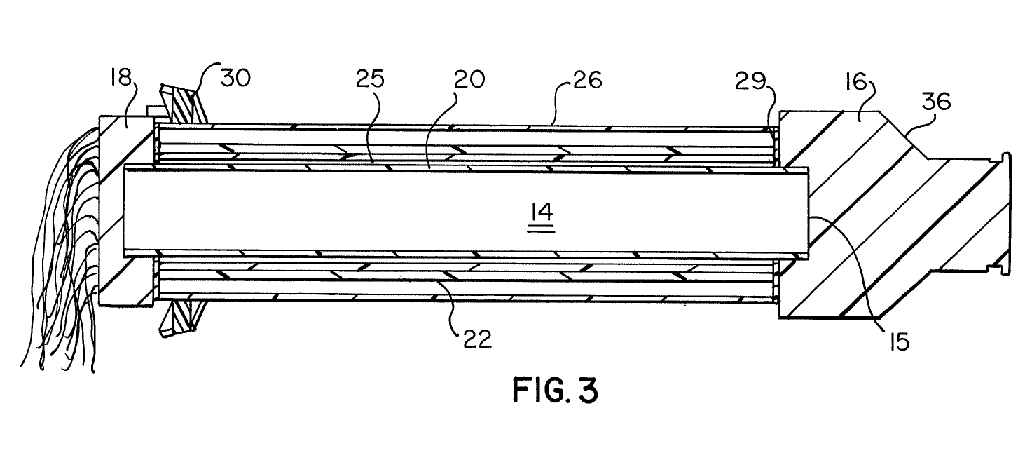

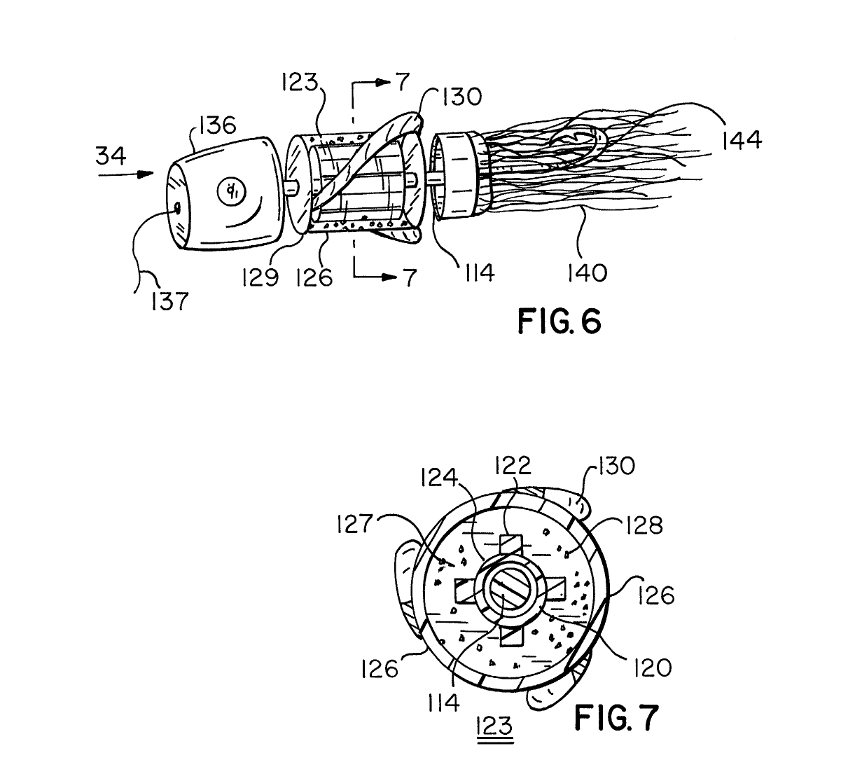

A forward portion 36 of the lure 10 may comprise any fluid dynamically suitable geometry such as the frustoconical geometry shown in FIGS. 1 and 3. It is however to be appreciated that other geometries such as that of a fish head 36 is shown in FIG. 6 may prove equally suitable for this purpose. In the embodiment of FIG. 1 there is also provided a simulated fish eye 38, several of which may be furnished circumferentially about front plate 16, to add further realism to the appearance of the lure. Fish line 37 is shown in FIG. 1.

In addition, it has been determined that the addition of streamers 40 are also advantageous in enhancing the effectiveness of the system. In like fashion, it has been found that a ticker 42 (see FIG. 1), which is rigidly attached to end plate 18, will produce a repetitive sound as it is oscillated by the rotation of said fins 30 of the system. Such a sound is attractive to certain fish.

In FIG. 5 is shown an embodiment of the invention that employs multiple fin sets 30 and 30a as well as mirrored surfaces 22a/22b and prismatic surfaces 24a/24b that alternate both longitudinally and circumferentially about inner sleeve 20.

In FIGS. 6 and 7 are shown a more generic expression of the invention which shows that any type of head 136 and tall and streamer arrangement 140 (including hook 144) may be placed upon a fixed axle 114 upon which a central hub 123 rotates by virtue of water force 34 against spiral fins 130 upon outer surface 126 thereof. Line 137 depends from fishhead 136. In the radial view of FIG. 7 may be seen the placement of reflective elements 122 and prismatic elements 124 as well as beads 128 on sleeve 120 within annular region 127 of the system. It may thereby be appreciated that a rotating reflective hub may be placed upon axle 114 to achieve the objects of this invention.

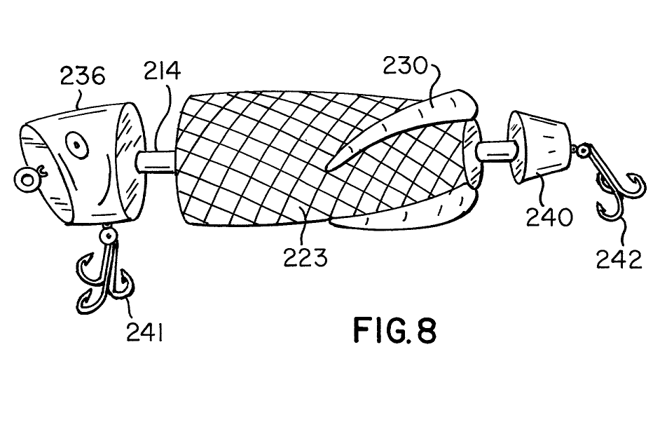

The embodiment of FIG. 8 illustrates rotational central body 223 may be finished with a reflective coating, thereby precluding use of any inner cylinder. Upon body 223 is applied spiral fins 230. Upon axle 214 is applied fishhead 236 and fishtail 240. Hooks 241/242 may be added thereto.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

Having thus described my invention what I claim as new, useful and non-obvious and, accordingly, secure by Letters Patent of the United States is:

1. A fishing lure comprising:
(a) a non rotational head assembly;
(b) a non-rotational tail assembly;
(c) an axle rigidly secured between opposing faces of said head and tail assemblies; and
(d) a hub-like substantially cylindrical body portion having an axial channel therein rotationally mounted about said axle, said cylindrical body portion comprising:
(i) spiral fins circumferentially dependent about an outer surface of said body portion; and
(ii) optical means secured upon said body portion,
whereby forward boat motion will induce water force against said fins and, thereby, rotation of said cylindrical body causing fish-attractive effects by said optical means.

2. The lure as recited in claim 1 in which said solid cylindrical body portion comprises:
a structure having a substantially transparent outer circumferential surface and an inner circumferential surface about said axial channel of said body portion in which said optical means are secured to said inner surface thereof.

3. The lure as recited in claim 2 in which said optical means comprise alternating longitudinal strips having mirrored and prismatic surfaces respectively.

4. The lure as recited in claim 3 in which beads or pebbles having optical effects are disposed between said inner and outer surfaces of said solid cylindrical body.

5. The lure as recited in claim 1 in which said head assembly simulates the appearance of a fish head.

6. The lure as recited in claim 2 in which said tall assembly simulates the appearance of a fishtail.

7. The lure as recited in claim 6 in which said tail assembly includes streamer elements.

8. The lure as recited in claim 7 in which said tail assembly includes a fishhook disposed within said streamers.

9. The lure as recited in claim 1 in which said spiral fins are axially disposed about at least one radial circumference.

10. The lure as recited in claim 1 in which said spiral fins are axially and longitudinally disposed about said body portion.

11. The lure as recited in claim 1 in which said cylindrical body includes noise-generating beads therein.
